(19) United States
(12) Patent Application Publication
(10) Pub. No.: US 2013/0159452 A1
(43) Pub. Date: Jun. 20, 2013

(54) Memory Server Architecture

(71) Applicants: Manuel Alejandro Saldana De Fuentes, Toronto (CA); Paul Chow, Toronto (CA)

(72) Inventors: Manuel Alejandro Saldana De Fuentes, Toronto (CA); Paul Chow, Toronto (CA)

(21) Appl. No.: 13/693,033

(22) Filed: Dec. 3, 2012

Related U.S. Application Data
(60) Provisional application No. 61/567,514, filed on Dec. 6, 2011.

(51) Int. Cl. G06F 15/167

(52) U.S. Cl. CPC G06F 15/167
USPC 709/213

(57) ABSTRACT

A memory server system is provided herein. It includes a first plurality of Field Programmable Gate Arrays (FPGA) application server nodes that are configured to parse the location of the FPGA data server nodes; a second plurality of FPGA data server nodes that are configured as memory controllers, each of the second plurality of FPGA data server nodes being connected to a plurality of RAM memory banks; and a network connection between the first plurality of FPGAs and the second plurality of FPGA processing nodes.

The present application claims the benefit of and incorporates by reference herein in its entirety U.S. provisional patent application Ser. No. 61/567,514 filed Dec. 6, 2011, entitled “RAM Server”.

### CROSS-REFERENCE TO RELATED APPLICATIONS

This application is related to subject matter in the invention described in the aforesaid U.S. provisional patent application Ser. No. 61/567,514 filed Dec. 6, 2011, entitled “RAM Server”.

### FIELD OF THE INVENTION

This invention relates to storage of data used by information systems and more particularly relates to reducing access latency to the stored data.

### BACKGROUND OF THE INVENTION

In a cloud or data center computing platform, where Internet-based applications rely on client-server models, efficient data access by the Application Server is essential to scale with the increase in demand of the services. Conventionally, application data is stored on high-density, non-volatile media such as hard disk drives (hereinafter, HDD). As technology evolves, the storage capacity of HDDs has increased considerably but the access time has remained largely unchanged becoming the performance bottleneck of modern data-oriented applications. To cope with the increase in demand in volume of requests, typical in client-server applications, application providers add more servers, but in doing so they also increase the access time latency due to additional infrastructure, such as extra layering of network switches to connect servers in the data center.

One method for reducing the latency of accessing data is to use volatile memory (i.e. random access memory or RAM) as the main storage media because RAM has lower access times than HDDs. Another is to enhance the network infrastructure to reduce access latency introduced by the network as more servers are added. Usually, this enhancement is achieved by acquiring optimized, more expensive network switches. Finally, software-based solutions in the form of libraries (e.g. Memcached, an open source, high-performance, distributed memory object caching system) can be used to implement a hybrid approach, where data is first searched in a dedicated Data Server that provides abundant RAM memory and if it is not found in a Data Server, then the data is searched in the HDDs. If data is found in the HDDs, then it is loaded into the Data Server for future reference.

In the present usage, a database server and a Data Server are conceptually different servers. The database server provides permanent storage, typically using HDDs, and is accessed using software such as MySQL. On the other hand, the Data Server is mostly RAM memory and is accessed using libraries such as libMemcached.

Such latency reducing systems require an efficient architecture for the RAM memory, an efficient mechanism for indexing and then accessing the RAM memory, and a system architecture that works well within a client-server environment.

### AIMS OF THE INVENTION

Among the aims of this invention are:

To address the latency problem with the use of hardware acceleration;

To address the latency problem with a novel system architecture;

To improve system efficiencies with a dedicated system for providing distributed, large-scale RAM storage;

To add in-line pre-processing capabilities for data before it is sent for storage and after it is retrieved from storage.

The invention in its general form will first be described, and then its implementation in terms of specific embodiments will be detailed with reference to the drawings following hereafter. These embodiments are intended to demonstrate the principle of the invention, and the manner of its implementation. The invention in its broadest sense and more specific forms will then be further described, and defined, in each of the individual claims that conclude this Specification.

### SUMMARY OF THE INVENTION

In an aspect of the present specification, there are provided several approaches for use in client-server systems that reduce the latency of access to large-scale memory systems. The client systems make requests for data to the Application Server systems over a network, such as the Internet. The Application Server systems will usually access data from a database server. The Application Server and the database server are usually connected via a network, such as the Internet or a local area network (hereinafter LAN). A key contributor to the overall response time to the requesting client server is the time for the Application Server to retrieve data from the database server.

Configurable logic devices, such as Field-Programmable Gate Arrays (hereinafter, FPGAs), are used to accelerate functionality currently implemented in software. The FPGAs can be incorporated into the Application Servers, the Data Servers, or both the Application Servers and Data Servers. Functionality, such as network protocol handling, encryption, compression, key hashing, and other inline processing functions can be integrated into the FPGAs. In some cases, the network architecture is modified. It can be desired to implement large-scale memory systems according to the teachings herein that describe system architectures and hardware structures to implement the systems.

### STATEMENTS OF THE INVENTION

A broad first aspect of this invention provides a memory server architecture comprising: front-end FPGAs in a plurality of Application Server nodes, which are configured to compute the memory location to be accessed in the Data Server nodes; back-end FPGAs in a plurality of Data Server nodes, which are configured as memory controllers, each of the back-end FPGAs being connected to a plurality of RAM; and a connection network between the front-end FPGAs of the Application Servers and the back-end FPGAs of the Data Servers.

A broad second aspect of this invention provides a memory server architecture comprising:

a) an Application Server computing platform programmed to host software applications directly in an Internet-accessible environment, and indirectly, using a network to access data b) a plurality of Application Servers being configured to provide the indirect connection to the LAN; and c) the LAN providing access to a HDD database server or access to a plurality of FPGA-based memory servers.

A broad third aspect of this invention provides a memory server architecture comprising:

a) an Application Server computing platform programmed to host software applications directly in an Internet-accessible environment, and indirectly, using a network to access data, b) a plurality of Application Servers being configured to provide the indirect access to data over a LAN, c) the Application Servers being structured to utilize a FPGA (i.e., front-end FPGAs); d) the LAN providing access to a HDD database server or access to a plurality of FPGA-based memory servers.

A broad fourth aspect of this invention provides a memory server architecture comprising:

a) an Application Server computing platform programmed to host software applications directly in an Internet-accessible environment and directly accesses a plurality of Data Servers; and b) each of the plurality of Application Servers accessing an associated plurality of Data Servers by a direct point-to-point link.

A broad fifth aspect of this invention provides a memory server architecture comprising:

a plurality of Application Servers operatively connected to a networked computing environment; an Application Server communicating with the plurality of client devices over the networked computing environment, the Application Server including processing hardware, the processing hardware comprising a plurality of groups of FPGAs to serve data requests; a first group of FPGAs (back-end FPGAs) structured to be placed inside the Data Servers to provide a first level of optimization and to optimize communications; a second group of FPGAs (front-end FPGAs) structured to reside in the Application Servers to further optimize communications and to comprise a second stage of optimization; and the first group of FPGAs being operatively connected to the second group of FPGAs whereby both groups of FPGAs are structured to communicate with each other, thereby avoiding the use of network switches, and thus decrease network latency.

A broad sixth aspect of this invention provides a plurality of programmed FPGAs (back-end FPGAs) that have been programmed to act as Data Servers; the programming of each FPGA providing an Ethernet interface to communicate using a LAN; a TCP/IP bridge or a UDP bridge operatively connected to the Ethernet interface; a Network-on-Chip (hereinafter NoC) connected to the TCP/IP bridge or UDP bridge; the NoC being operatively connected to an inter-chip interface for connection to other FPGAs; the NoC being operatively connected to a plurality of memory agents; each memory agent being connected to an associated memory controller; and each memory controller being implemented as logic in the FPGA, or using external logic, or a combination of internal FPGA logic and external logic.

A broad seventh aspect of this invention provides a plurality of programmed FPGAs (front-end FPGAs) that have been programmed to respond to application memory requests; the FPGA programming providing a standard host interface, such as PCIe or Intel QPI, which is operatively accessible by an application software command protocol; the PCIe or QPI interfaces being structured to communicate directly with a hardware proxy that interprets the software commands; the hardware proxy being structured to communicate directly with a Hash Engine; the Hash Engine being structured to communicate directly with a Compression Engine; the Compression Engine being structured to communicate directly with an Encryption Engine; the Encryption Engine being structured to communicate directly with an Ethernet TCP/IP or UDP Packet generator; the Ethernet TCP/IP or UDP Packet generator connecting to an Ethernet port; the hash engine also being optionally structured to communicate directly with a memory agent; the memory agent being directly connected to a memory controller; and the memory controller being implemented as logic in the FPGA, or using external logic, or a combination of internal FPGA logic and external logic.

A broad eighth aspect of this invention provides two mechanisms for distributed data storage. The first mechanism using a key-value pair, where the key is hashed in the front-end FPGAs in the Application Server to determine the location of the corresponding Data Server and hashed again in the back-end FPGAs in the Data Server to determine the Local RAM address on the Data Server. The second mechanism using an address-value pair, where a Global Address is determined in the Application Server and then mapped in the front-end FPGAs of the Application Server to determine the corresponding Data Server, where the back-end FPGAs map the Global Address into a Local RAM address on the Data Server.

A broad ninth aspect of this invention provides a plurality of programmed FPGAs (front-end FPGAs) that have been programmed to respond to application memory requests issued from the application, such as a web server (e.g., the Apache Web Server), running on the Application Server. The application running on the Application Server interfaces with a front-end FPGA through an Application Program Interface (hereinafter API) for programming languages including, but not limited to PHP, Python, C, and C++.

### OTHER FEATURES OF THE INVENTION

Features of the broad first aspect of this invention provide the following features of the memory server system:
a) the first plurality of back-end FPGAs are connected to a plurality of high-speed network connections, or wherein the first plurality of back-end FPGAs are operatively connected electrically to RAM memory, thereby to stored data;
b) the first plurality of back-end FPGAs are operatively connected by a mesh or ring or other topologically suitable connection to a plurality of nearest neighbors to form an interconnected structure of memory accessing nodes in a network;
c) each of the back-end FPGAs are structured to control a dynamically allocated amount of RAM;
d) the back-end FPGAs contain hardware processing units, implementing functions with FPGA logic, or embedded microprocessors, executing software, or a combination of hardware processing units and embedded microprocessors;
e) the second plurality of front-end FPGAs are operatively connected to switches over a network;
f) further comprising a client-server computing system based on FPGAs that have been programmed to make data requests more efficient in data centers;
g) the memory agents in the FPGAs, which are configured as memory servers, comprise functions to act as Memcached servers or other similar key-value Data Server functions;
h) the memory agents within the FPGAs, which are configured as memory servers, comprise functions to act as other data-caching servers;
i) the FPGAs are configured to provide a distributed Data Server that is programmed to perform key hashing to determine memory addresses to service data read and write requests;
j) the FPGAs are configured to provide a distributed Data Server that is programmed to use address-value pairs instead of key-value pairs;
k) the FPGAs are configured to provide Data Servers and are operatively interconnected using different topologies, and with multiple access ports to high-speed LAN networks and each FPGA with access to a plurality of RAM;
l) the different topologies, are configured as ring or mesh or other suitable topology;
m) the FPGAs are configured to integrate with the Application Server to off-load memory request-related tasks, preferably wherein the off-loaded memory request-related tasks are hashing keys to IP addresses or keys to Local memory in the plurality of RAM or further preferably wherein the FPGAs are configured to provide a tight interconnection to the main system memory of the Application Server via PCIe or Intel QPI bus connections to perform the off-loaded memory request-related tasks;
n) the FPGAs are configured to have multiple network connection ports thereby to provide direct point-to-point connections with other network nodes;
o) wherein the FPGAs are configured to have access to high-speed connections to typical non-volatile storage database servers to store data permanently,
p) wherein the Data Server comprises a RAM Data Server and the RAM Data Server comprises a plurality of FPGAs;
q) wherein the plurality of FPGAs each include a Memcached server or other similar key-value functionality;
r) wherein the Memcached server, or other similar key-value functionality, is implemented in FPGAs;
s) the preferred embodiment of an embedded processor is implemented within the FPGA, but it could also be an external microprocessor chip closely connected to the FPGA.

Features of the broad second aspect of this invention provide the following features of the memory server system:
a) the Application Servers comprise a plurality of CPU servers preferably wherein the plurality of CPU servers each include a Web server, or other similar server functionality.
b) the Data Server comprises a RAM Data Server and the RAM Data Server comprises a plurality of FPGAs, preferably the plurality of FPGAs each include a Memcached server or other similar key-value functionality, and further preferably wherein the Memcached server, or other similar key-value functionality, is implemented in FPGA hardware.

Features of the broad third aspect of this invention provide the following features of the memory server system:
a) the Application Servers comprise a plurality of CPU servers preferably wherein the plurality of CPU servers each include a libMemcached client or other similar key-value functionality;
b) the plurality of front-end FPGAs each can include a libMemcached client or other similar key-value functionality; preferably wherein the libMemcached client, or other similar key-value functionality, is structured to be implemented in hardware, preferably, implemented in FPGA hardware.

Features of the broad fourth aspect of this invention provide the following features of the memory server system:
a) the plurality of FPGAs in the Application Server are structured to access the plurality of FPGAs in the Data Servers directly with point-to-point links.

Features of the broad fifth aspect of this invention provide the following features of the memory server system:
a) the memory server system includes a plurality of Application Servers accessing a separate TCP/IP or UDP network to access a non-volatile HDD-based database.

Features of the broad sixth aspect of this invention provide the following features of the programmed FPGA:
a) the inter-chip interface is structured to interface with other FPGAs within the same cluster of FPGAs;
b) the Data Server hardware comprises hardware preferably FPGA hardware;
c) the hardware components implemented in the back-end FPGAs are linked by a Network-on-Chip.

Features of the broad seventh aspect of this invention provide the following features of the programmed FPGA:
a) a Memcached server, or similar key-value functionality can be implemented directly on the Application Server FPGAs;
b) additional in-line processing capabilities applicable to the data that is to be stored in the RAM Data Server or retrieved from the RAM Data Server.

Features of the broad eighth aspect of this invention provide the following features of the memory server architecture
a) a data storage and retrieval approach based on a key-value mechanism;
b) a data storage and retrieval approach based on a address-value mechanism.

Features of the broad ninth aspect of this invention provide the following features of the memory server architecture:
a) an API that provides access to the front-end FPGAs in the Application Server;
b) the API providing a high-level interface that simplifies the complexities of controlling the front-end FPGA and exchanging data with the front-end FPGA, thereby making programming easier and faster;
c) the API being available in a plurality of computer programming languages.

### Brief Description of the Inventive Concept

In summary, the present invention first provides a device that uses a plurality of FPGAs instead of software programmed processors, such as X86 processors, to serve data requests. This first plurality of FPGAs resides in the Data Servers and provides a first level of optimization, known as O1, to be described in detail in FIG. 2.

Subsequently, a second plurality of FPGAs are provided inside the Application Servers further to optimize communications. This second plurality of FPGAs provides a second stage of optimization, known as O2, to be described in detail in FIG. 3.

Finally, the first plurality of FPGAs and the second plurality of FPGAs are structured to communicate with each other to avoid the use of network switches. This serves to decrease network latency even further. This third level of optimization, known as O3, to be described in detail in FIG. 4.

In Stage O1, the optimization occurs in the Data Servers by replacing software functions with hardware implemented in the back-end FPGAs. When the preferred embodiment of this invention is Memcached (or any key-value system), software functions including, but not limited to protocol parsing, key hashing, cache eviction, memory slab allocation, dynamic memory handling, compression, encryption and other TCP/IP-related functions, such as checksum calculations, are implemented entirely or partially in hardware in the back-end FPGAs.

In a preferred aspect of this invention, multiple FPGAs are tightly connected together to scale up the total amount of memory in the system with reduced communication latency between them. Different interconnection topologies may be used including but not limited to mesh, torus, ring or tree such that latency is minimized. The actual interconnection will depend on the communication pattern required by an application and by the eventual product model number. This set of tightly coupled FPGAs and memory could replace the HDD-based database servers of the prior art, to be described in detail in FIG. 1. It is conceived that HDD-based database servers can still be maintained to have a hybrid approach, e.g., in database caching systems. In the case of a preferred system running Memcached, the Memcached server is implemented entirely, or partially, in hardware, and multiple instances of such servers may be provided.

For data centers with only O1 optimization, the Application Servers may contact the Data Servers by re-using existing standard LAN infrastructure with TCP/IP and UDP network protocols and existing software libraries, e.g., libMemcached (running on the Application Server).

In Stage O2, FPGAs are placed inside the Application Servers to further reduce the communication latency. Some processing functions, including, but not limited to protocol parsing, key hashing, cache eviction, memory slab allocation, dynamic memory handling, compression, encryption and other TCP/IP-related functions, such as checksum calculations, may be off-loaded to the front-end FPGA, thus allowing the Application Server to process more requests from the remote clients. In addition, off-chip memory attached to the front-end FPGA of the Application Server may potentially be used as a Level-1 (L1) cache that may avoid a longer trip to the Data Server to obtain the data. In the case of a system that uses Memcached, the Memcached client (e.g. libMemcached) could run partly in software and partly in hardware.

In Stage O3, FPGAs, on both the Application Servers and the Data Servers, may be structured with multiple network connections to allow them to communicate directly between servers using direct point-to-point links forming different topologies of interconnected servers, e.g., mesh, 3D-torus or trees, depending on the communication traffic pattern. In such case, the typical network switches are no longer necessary and packet routing can be done by the FPGAs themselves. By eliminating the network switches, the actual protocols no longer need to be TCP/IP or UDP, which introduce considerable overhead, but another protocol more efficient and tailored to the architecture.

The typical Memcached paradigm does not require communication between servers. Therefore, there is no need to have fully-connected FPGAs. A simple Tree topology would suffice. However, there might be other uses for such communication infrastructure. By the same token, communication between boards, or clusters of FPGAs, is also not a requirement.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

In the accompanying drawings:

FIG. 1 is a schematic block representation of a typical prior art Internet-based client-server computing system with Application Servers and database servers;

FIG. 2 is a schematic block representation of a memory server architecture of one embodiment of this invention providing Data Server optimization; by providing FPGAs in the Data Servers;

FIG. 3 is a schematic block representation of a memory server architecture of another embodiment of this invention providing Application Server optimization and reduction of network latency on the Application Server; by providing FPGAs in the Application Servers;

FIG. 4 is a schematic block representation of a memory server architecture of another embodiment of this invention for memory server optimization by providing switchless network optimization;

FIG. 5 is an idealized schematic block representation of one embodiment of a programmed back-end FPGA in one embodiment of a memory server architecture of an embodiment of this invention showing the inside of a programmed back-end FPGA in the Data Server;

FIG. 6 is an idealized schematic block representation of another embodiment of a front-end FPGA in one embodiment of a memory server architecture of an embodiment of this invention showing the inside of a programmed front-end FPGA in the Application Server; and

FIG. 7 is a schematic block representation of one embodiment of this invention showing a board with multiple FPGAs per board, multiple network access points and one host bus connection, such as PCIe or QPI; the board being a preferred embodiment for the front-end and back-end FPGAs.

Before describing the above Figures, applicant now provides brief definitions of the terms used in this description.

Address-Value Pair: The Address is a fixed-length sequence of bits conventionally displayed and manipulated as an unsigned integer. An Address determines explicitly the location of a data Value or data Object in memory.

Compression engine: a system for compressing data to smaller sizes.

CPU server: a computing system typically comprising X86 processors.

DB or database: an organized way to keep records of data, typically on hard disk drives.

DDR3: Double Data Rate, type 3 synchronous dynamic random access memory.

DMA or Direct Memory Access: a system for communicating with memory, namely a means to transfer from RAM (Random Access Memory) to another part of a computer without using the CPU (Central Processor Unit).

Encryption Engine: a system for scrambling data to limit access to those who can descramble.

FPGA or Field Programmable Gate Array: finely configurable semiconductor computer chips. FPGAs can be used to implement any logical function that an application-specific integrated circuit can perform but they have the ability to upgrade the functionality. They contain programmable logic components and a hierarchy of reconfigurable interconnects. FPGAs also have many embedded functions such as adders, multipliers, memory and input/output circuits or even microprocessors. Some brand names include Xilinx, Altera and Lattice. In this description, the term “FPGA” is used interchangeably with “Configurable Logic Device”, i.e., any device that has configurable logic, of which an FPGA is only one example.

Global Address: a fixed-length sequence of bits conventionally displayed and manipulated as an unsigned integer that uniquely identifies a RAM address within the plurality of RAM distributed across the plurality of Application Servers and the plurality of Data Servers.

Hash Engine: a system for finding where data is stored based on a Key in a Key-Value Pair;

Key-Value Pair: The Key is a variable-length label that is associated to a data Value, or more generally a data Object.

L1 cache or Level 1 cache: a memory bank usually of small data storage capacity but extremely low access latency. Typically, built into a CPU chip or packaged on the same module as the chip. The L1 cache feeds the processor.

libMemcached: an open source (non-copyright) computer code C/C++ Memcached client library that runs on Application Servers. It was designed to be light on memory usage, thread safe and provide full access to server side methods. Among its many features are: asynchronous and synchronous transport support; consistent hashing and distribution; tunable hashing algorithm to match keys; access to large object support; local replication; and tools to manage Memcached networks.

Local Address: a fixed-length sequence of bits conventionally displayed and manipulated as unsigned integer that uniquely identifies a RAM address within a specific Application Server or Data Server.

LVDS or Low Voltage Differential Signaling: a way to connect two chips together, namely an electrical signaling standard that can run at very high speeds over inexpensive pairs of copper wires.

Memcached: it is a free and open source, high-performance, distributed memory object caching system, generic in nature, but intended for use in speeding up dynamic web applications by alleviating database load. Memcached is an in-memory, key-value store for small pieces of arbitrary data (e.g. strings, objects) from results of database calls.

Memory Bank: A collection of memory locations that could be implemented as a single block inside an integrated circuit or one or more memory chips when the bank is implemented using memory chips or memory modules.

NoC or Network-On-Chip: is an approach to designing the communication subsystem between cores inside an electronic chip.

PCIe: a physical standard for connecting peripherals to a computer. It is a high-speed expansion card format that connects a computer with its peripherals.

QPI or Quick Path Interconnect: It is a point-to-point processor interconnect developed by Intel that replaces the front-side bus (FSB) in desktop platforms.

RAM or Random Access Memory: In a broad sense, randomly addressable storage locations, typically implemented in semiconductor-based memories such as static random access memory (SRAM) and dynamic random access memory (DRAM). In this description, we also include non-volatile memories, such as FLASH memory. This could exist in the form of discrete integrated circuit chips or in modules often known as DIMMs, SODIMMs and the like.

TCP/IP or Transmission Control Protocol/Internet Protocol: a networking protocol that the Internet uses, namely a set of rules used along with the Internet Protocol to send data in the form of message units. TCP keeps track of the packets into which a message is divided for efficient routing through the Internet.

Tree, ring, mesh or torus topologies: are ways of connecting a set of computing nodes in a network.

UDP or User Datagram Protocol: another protocol (way of communicating) that the Internet uses, namely a communications protocol that offers limited amounts of service when messages are exchanged between computers in a network that uses the Internet Protocol.

X86: a generic term for a series of Intel and Intel-compatible microprocessor families.

As used herein, the term “server” includes virtual servers and physical servers.

As used herein, the term “computer system” includes virtual computer systems and physical computer systems.

As used herein, the term “node” means a communication endpoint in a network.

As used herein, the term “board” includes one or more clusters of FPGAs.

As used herein, the term “cluster” means: a logical group of FPGAs, which can be interconnected with direct physical wires (e.g. using LVDS to connect two FPGAs) in a given topology (e.g. Tree, fully-connected, mesh, etc). One cluster could share one or more Ethernet ports or any other type of network connections

### DETAILED DESCRIPTION OF THE DRAWINGS

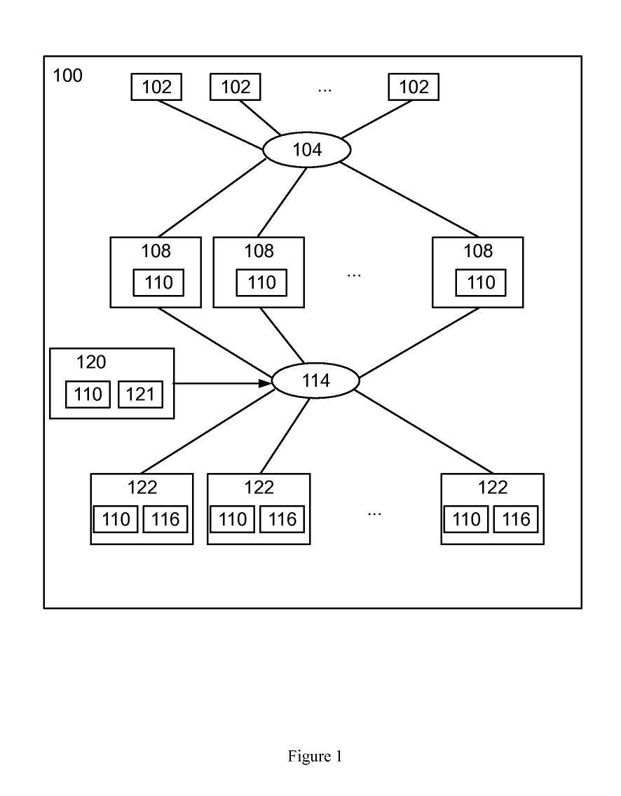

### Detailed Description of FIG. 1

FIG. 1 shows the typical prior art block implementation of an Internet-based application that relies heavily on databases and is indicated by the general reference number 100.

Remote clients 102 access the Internet 104, which communicates with a plurality of Application Servers 108. The plurality of Application Servers function as Web servers and may each comprise a microprocessor, e.g. an X86 110, that executes the Web server code. The Application Servers 108 receive requests from the remote clients 102 over the Internet 104. In turn, these Application Servers 108 need to request vast amounts of data from the database servers 120, which have a high access latency because the data is stored on a hard drive 121. To alleviate this, dedicated Data Servers 122 are introduced where data is stored in RAM. The Data Servers 122 generally consist of a plurality of microprocessors, e.g. an X86 110 running Memcached 116, or any other data-caching server program. Thus, current solutions use standard X86 processor-based systems to run both the Application Servers 108 and the Data Servers 122. All communication traffic goes through a centralized switch or Local Area Network (LAN) 114.

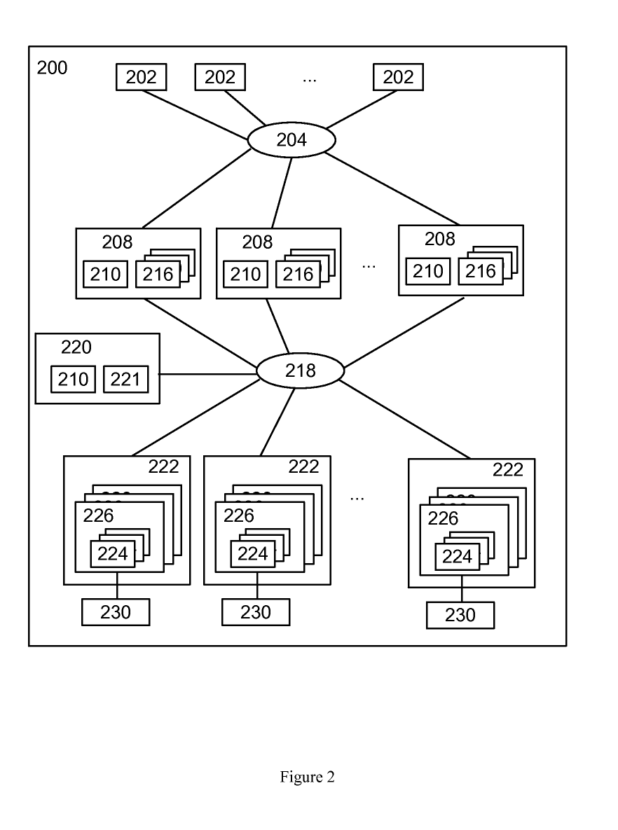

### Detailed Description of FIG. 2

FIG. 2 shows a Stage O1 system of one embodiment of this invention and is indicated by the general reference number 200. Stage O1 provides Data Server optimization by using a plurality of Data Servers 222, each Data Server 222 including a plurality of back-end FPGAs 226, each FPGA 226 including a plurality of Memcached servers 224 implemented entirely, or partially, in hardware; each Memcached server 224 having access to a plurality of RAM 230.

Remote clients 202 access the Internet 204, which communicates with a plurality of Application Servers 208, a preferred embodiment of the Application Servers are Web-servers. The plurality of Application Servers 208 in this Stage O1 may each comprise a microprocessor, e.g. an X86 210, that can compute the location of the data to be accessed by the plurality of Data Servers 222. The Application Servers 208 use a software library 216 to request data from the Data Servers 222. The Application Servers 208 use a preferred embodiment of the key-value system, namely libMemcached 216, i.e. an open source computer code client library and tools for running Memcached. Multiple copies of the libMemcached client 216 or any other library of similar functionality, such as the one described in this disclosure, can be implemented in software and executed by the X86 processor 210.

Based on a location specified by the Application Servers 208, the data may be associated to a key in a key-value system, such as data caching with Memcached, or associated to an address in a Global address space using an address-value pair. If the data location is associated to a key, then the FPGAs 226 on the Data Servers 222 perform a hashing function that translates the key into a Local memory address on the Data Server 222.

The Application Servers 208 are structured to exchange data through a central switch 218 using TCP/IP or UDP or other custom protocol to store and retrieve data from database servers 220 consisting of a microprocessor, e.g. an X86 210, and an HDD-based database 221. When the Data Servers 222 do not contain the requested data, then the Application Servers 208 will access the data from the database server 220.

In Stage O1, the Application Servers 208, the database servers 220 and the LAN infrastructure 218 of the data centers do not require any modification and current infrastructure can be reused. Only Data Servers 222 are modified but the changes are transparent to existing applications running on the Application Servers 208.

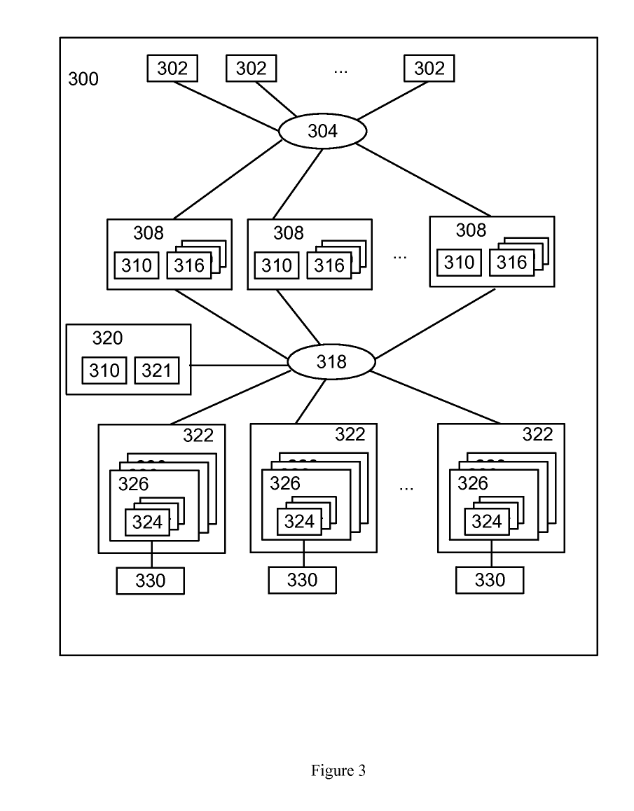

### Detailed Description of FIG. 3

FIG. 3 shows a Stage O2 optimization of one embodiment of this invention and is indicated by the general reference number 300. Stage O2 reduces network access latency on the Application Server 308, e.g., by off-loading Memcached client tasks to hardware.

Remote clients 302 access the Internet 304, which communicates with a plurality of Application Servers 308, a preferred embodiment of the Application Servers are Web-servers. The plurality of Application Servers 308 in this Stage O2, may each comprise one or more front-end FPGAs 316 that are placed inside the Application Servers 308 to reduce the communication latency. The application running in the Application Server 308 uses a software library, or API, such as libMemcached, executed by the X86 processor 310 to interact with the front-end FPGAs 316; each FPGA 316 containing the off-loaded functionality of the aforementioned software library.

Based on a location specified by the Application Servers 308, the data may be associated to a key in a key-value system, such as data caching with Memcached, or associated to an address in a Global address space using an address-value pair. If the data location is associated to a key, then the back-end FPGAs 326 on the Data Servers 322 perform a hashing function that translates the key into a Local memory address on the Data Server 322.

Additional processing functions, including, but not limited to protocol parsing, key hashing, cache eviction, memory slab allocation, dynamic memory handling, compression, encryption and other TCP/IP- or UDP-related functions, such as checksum calculations, are implemented entirely or partially in hardware in front-end FPGAs 316 thus allowing the Application Servers 308 to process more requests from the remote clients 302. In addition, off-chip memory (not shown in FIG. 3) attached to the FPGA 316 of the Application Server 308 is preferably used as a Level-1 cache that could avoid a trip to the Data Server 322 to obtain the data.

The Application Servers 308 are structured to exchange data through a central switch 318 using TCP/IP or UDP or other custom protocol to store and retrieve data from database servers 320 consisting of a microprocessor, e.g. an X86 310, and an HDD-based database 321. When the Data Servers 322 do not contain the requested data, then the Application Servers 308 will access the data from the database server 320.

Stage O2 can build upon Stage O1, therefore one embodiment of this invention indicated by the general reference number 300 also provides a Data Server optimization by using a plurality of Data Servers 322, each Data Server 322 including a plurality of FPGAs 326, each FPGA 326 including a plurality of Memcached servers 324 implemented entirely, or partially, in hardware; each Memcached server 324 having access to a plurality of RAM 330.

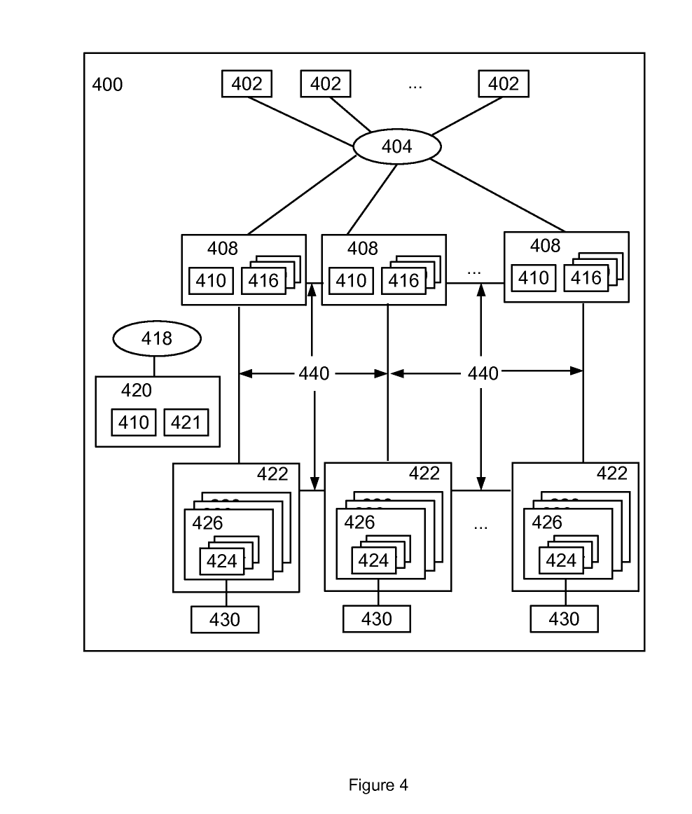

### Detailed Description of FIG. 4

FIG. 4 shows a Stage O3 optimization of one embodiment of this invention and is indicated by the general reference number 400, and uses two networks to separate the traffic between the Application Servers and the database servers, and the traffic between the Application Servers and the Data Servers. One network uses direct point-to-point connections 440 to provide high performance topologies between Application Servers 408 and Data Servers 422. Each of the Application Servers 408 is structured to exchange data directly with another Application Server 408 or with a Data Server 422 by using point-to-point connections 440. Data exchanged between servers is routed by the FPGAs inside the servers, thus avoiding the centralized network switch 418. A secondary network using the centralized network switch 418 is still used where Application Servers 408 are structured to exchange data through the central switch 418 using TCP/IP or UDP or other custom protocol. For clarity, FIG. 4 omits the lines showing the connections from the Application Servers 408 and the network switch 418. The centralized network switch 418 is structured to transport data from the HDD-based database servers 420 consisting of a microprocessor, e.g. an X86 410, and an HDD-based database 421.

Stage O3 builds on O2 where remote clients 402 access the Internet 404, which communicates with a plurality of Application Servers 408, a preferred embodiment of the Application Servers are Web-servers. The plurality of Application Servers 408 in this Stage O3, may each comprise one or more front-end FPGAs 416 that are placed inside the Application Servers 408 to reduce the communication latency. The application running in the Application Server 408 uses a software library, or API, such as libMemcached, executed by the X86 processor 410 to interact with the front-end FPGAs 416; each FPGA containing the off-loaded functionality of the aforementioned software library.

Additional processing functions, including, but not limited to protocol parsing, key hashing, cache eviction, memory slab allocation, dynamic memory handling, compression, encryption and other TCP/IP- or UDP-related functions, such as checksum calculations, are implemented entirely or partially in hardware in front-end FPGAs 416 thus allowing the Application Servers 408 to process more requests from the remote clients 402. In addition, off-chip memory (not shown in FIG. 4) attached to the FPGA 416 of the Application Server 408 is preferably used as a Level-1 cache that could avoid a trip to the Data Server 422 to obtain the data.

The Application Servers 408 are structured to exchange data through a central switch 418 using TCP/IP or UDP or other custom protocol to store and retrieve data from database servers 420 consisting of a microprocessor, e.g. an X86 410, and an HDD-based database 421. When the Data Servers 422 do not contain the requested data, then the Application Servers 408 will access the data from the database server 420.

Stage O3 builds upon Stage O1, therefore one embodiment of this invention indicated by the general reference number 400 also provides a Data Server optimization by using a plurality of Data Servers 422, each Data Server 422 including a plurality of FPGAs 426, each FPGA 426 including a plurality of Memcached servers 424 implemented entirely, or partially, in hardware; each Memcached server 424 having access to a plurality of RAM 430.

To recapitulate, Stage O1 optimizes the Data Server, Stage O2 optimizes the Application Server and Stage O3 further optimizes the entire architecture by eliminating the need for a network switch.

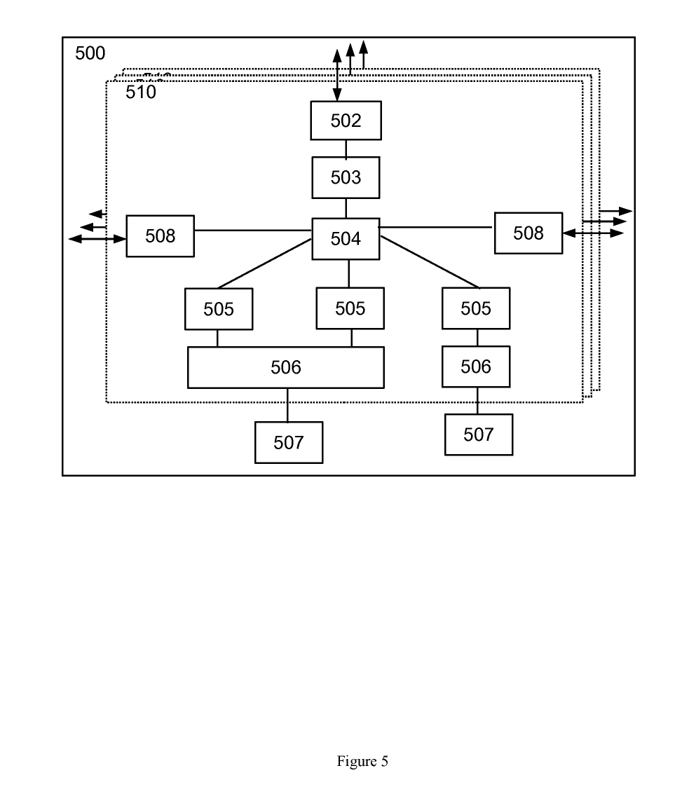

### Detailed Description of FIG. 5

FIG. 5 is an idealized schematic block representation of one embodiment of a programmed FPGA in one embodiment of the memory server architecture of an embodiment of this invention showing the inside of the programmed back-end FPGA in the Data Server, generally indicated by reference number 500.

The external configuration of a typical back-end FPGA 510 is shown in broken lines, i.e., to represent the external configuration of the back-end FPGA 510 whose programmed interior is to be described. There can be a plurality of back-end FPGAs 510 in Data Server 500. The typical back-end FPGA 510 as illustrated may be described as including, there within, a plurality of layered memory agents 505, a preferred embodiment of such memory agents are Memcached servers. Thus, Memcached servers 505, as previously described, are implemented entirely or partially in hardware.

As seen in FIG. 5, a network interface 502 receives and sends network data packets to and from the LAN network, where the network interface 502 is a bidirectional access point to the LAN. The network interface 502 is structured to communicate with the TCP/IP or UDP or other protocol bridge 503, which translates the destination and source ports in the network packets, such as Ethernet packets, to Network-on-Chip addresses.

The Network-on-Chip 504 is structured to communicate directly with a plurality of hardware memory agents 505. Each hardware memory agent 505 has access to an associated memory controller 506. In turn, the memory controllers 506 provide access to their associated RAM memory 507. The memory controller function is shown as entirely within the FPGA, but some aspect may be implemented externally to help manage electrical and interface timing issues.

The Network-on-Chip 504 is also structured to communicate with off-chip communication controllers 508, a preferred embodiment of such communication controllers are LVDS bridges, or any other form of bidirectional connection to adjacent FPGAs.

When the preferred embodiment of the memory agent is a hardware Memcached server, each Memcached server 505 performs the key hashing to determine the Local memory address to access. When the preferred embodiment of the hardware memory agent is an address-value system, then the address is used as is. An additional but optional Local address mapping can be performed by the memory agent if necessary. A memory agent 505 will issue read or write commands to the memory controllers 506, which in turn perform the actual read or write to the plurality of RAM memory 507.

As can be seen in FIG. 5, two or more hardware memory agents can share the same memory controller to access the same plurality of RAM memory to increase the memory utilization.

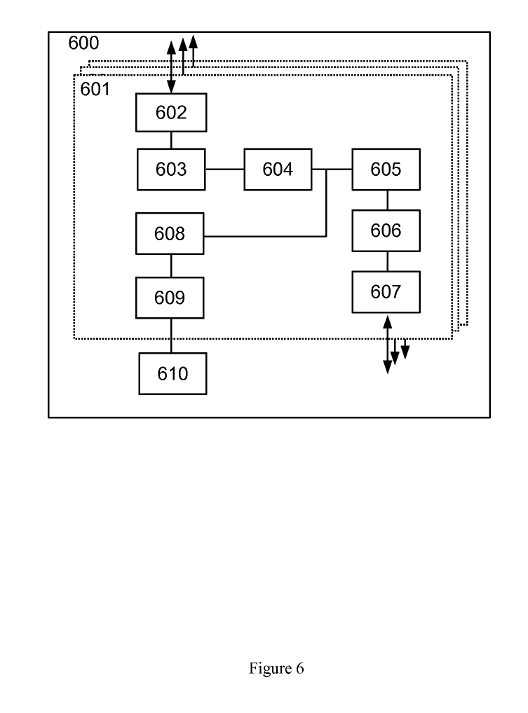

### Detailed Description of FIG. 6

FIG. 6 is an idealized schematic block representation of another embodiment of a programmed front-end FPGA 601 in an embodiment of a memory server architecture of an embodiment of this invention showing the inside of the programmed front-end FPGA 601 in the Application Servers, generally indicated by reference number 600.

As seen in FIG. 6, the front-end FPGAs 601 in the Application Servers 600 are programmed so that there is an input and output communication link through a host interface 602, such as PCIe or QPI, which is structured to access a hardware proxy module 603. The hardware proxy 603 interprets the commands from the application software, which would use a standard or custom API. The hardware proxy 603 performs efficient memory access, such as DMA, to and from the Application Server main memory. The hardware proxy 603 communicates with a hash engine 604, which in turn communicates with a compression engine 605 and then with an encryption engine 606. Encryption engine 606 communicates with an Ethernet TCP/IP or UDP packet generator 607 that sends and receives packets to and from the LAN. This embodiment of the front-end FPGA in the Application Server shows how some functions can be off-loaded to the FPGA to make the overall system more efficient. The key hashing is performed by the hash engine 604 only when the preferred embodiment of the memory server architecture uses a key-value system, such as Memcached. Otherwise, a different address mapping approach may be used to obtain the IP address of the Data Server.

The hash engine 604 can also communicate with a local memory agent 608, a preferred embodiment of such memory agent 608 is a Memcached server. Thus, Memcached servers 608, as previously described, are implemented partially or entirely in hardware. The memory agent 608 accesses a memory controller 609. The memory controller 609 accesses an on-board RAM memory 610 that can act as a Level-1 (L1) cache to avoid going to the network to access remote data.

Applications running in the Application Server, such as Web servers can share the same front-end FPGA 601. However, the proposed invention provides the potential to include one or more front-end FPGAs per Application Server 600. A preferred embodiment of the Application Servers 600 are Web servers, which may use a Memcached client application program interface (API) based on PHP, Python, Perl, Ruby or C to have access to the front-end FPGA 601.

In summary, the typical Memcached paradigm does not require communication between servers. Therefore, there is no need to have fully-connected FPGAs. Communication between boards or clusters of FPGAs is also not a requirement. In one embodiment, a simple Tree topology may suffice. It is theorized, however, that there might be other uses for such communication infrastructure.

The aforesaid hash engine 604, compression engine 605 and encryption engine 606 may be pipelined in time to increase the efficiency. The compression engine 605 and the encryption engine 606 are optional in an embodiment of the present invention. The TCP/IP-UDP packet generator 607 can generate the packet checksum. When an embodiment of the present invention uses a key-value system, an instance of the Memcached server (hardware agent 608), which is typically instantiated in the Data Server FPGAs, may also be instantiated in the same Application Server FPGA 601 to act as a Level-1 cache.

FIG. 6 thus shows an embodiment of this invention with front-end FPGA 601 designed for the memcached client running on the Application Server 600 (e.g., Web server). The front-end FPGA 601 contains an interface to the Application Server main memory via the host interface 602 with Direct Memory Access (DMA) functionality. The hardware proxy 603 is structured to decode the Memcached commands. The Memcached hardware proxy 603 is structured to be shared by one or more Memcached clients. There can be more than one front-end FPGA 601 per Application Server.

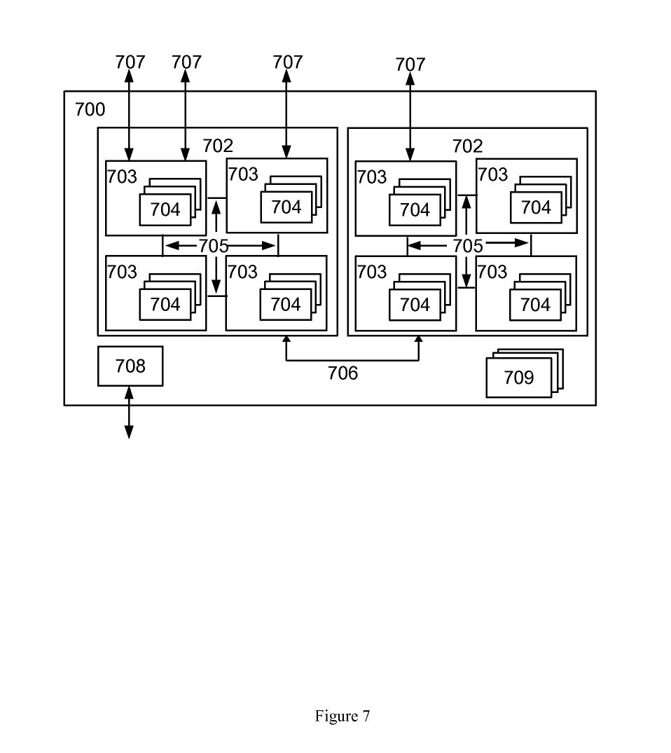

### Detailed Description of FIG. 7

FIG. 7 is an idealized schematic block representation of one embodiment of a multiple FPGA board in one embodiment of the memory server architecture of an embodiment of this invention showing the structure of a multiple FPGA board identified by the general number 700.

As seen in FIG. 7, in an embodiment of the invention, the board 700 contains two FPGA clusters 702 with four FPGAs 703 per cluster. Each FPGA 703 contains three Memcached servers 704 (memory agents) per FPGA 703. Each board 700 contains a plurality of RAM 709 wherein each RAM 709 is connected to at least one FPGA 703. Connections between RAM 709 and FPGAs 703 are not shown in FIG. 7 for clarity. The board 700 has access to four Ethernet network connections 707 that are structured to communicate with all eight FPGAs through the intra-cluster communication links 705 and inter-cluster communication links 706. The board is provided with a plurality of interconnected LVDS lines 705 that comprise the intra-cluster communication links so that all the FPGAs in a cluster are connected with a mesh or tree topology. The inter-cluster communication 706 can also be a plurality of LVDS lines or any other form of communication that would help manage electrical and interface timing issues.

The aforesaid number of clusters 702, FPGAs 703 and hardware Memcached servers 704 (memory agents) may vary depending on the particular embodiment of this invention.

The multiple FPGA board 700 can be used to provide front-end and back-end FPGAs to the Application Servers and Data Servers, respectively. The host interface 708 is connected to at least one FPGA 703. The connections between the host interface 708 and the FPGAs 703 are not shown in FIG. 7 for clarity. The front-end FPGAs use the host interface 708 to receive commands from applications running in the Application Server. The back-end FPGAs may use the host interface 708 for monitoring and management purposes. The preferred embodiment of the host interface 708 includes, but is not limited to PCIe and QPI.

### Conclusion

The foregoing has constituted a description of specific embodiments showing how the invention may be applied and put into use. These embodiments are only exemplary. The invention in its broadest, and more specific aspects is further described and defined in the claims that follow.

These claims, and the language used therein are to be understood in terms of the variants of the invention that have been described. They are not to be restricted to such variants, but are to be read as covering the full scope of the invention as is implicit within the invention and the disclosure that has been provided herein.

1. A memory server architecture comprising:
A plurality of Application Server nodes executing software applications in an Internet-accessible environment;
wherein the plurality of Application Servers are programmed to access data from a plurality of Data Servers;
wherein the plurality of Data Servers respond to data requests from the plurality of Application Servers;
wherein the plurality of Data Servers comprises a first plurality of back-end FPGAs structured to provide access to a plurality of RAM;
wherein the first plurality of back-end FPGAs are configured to process data requests in the form of key-value or address-value pairs.

2. The memory server architecture of claim 1, wherein
the key in a key-value format is hashed by the back-end FPGAs to determine the Local Address on a Data Server;
and the Global Address in an address-value format is used directly by the back-end FPGAs or mapped by the back-end FPGAs to a Local Address on a Data Server.

3. The memory server architecture of claim 1, wherein
the first plurality of back-end FPGAs can perform in-line processing on the data to be stored and retrieved from the plurality of RAM on a Data Server;
wherein the in-line processing operations performed on the data includes, but is not limited to protocol parsing, key hashing, compression, encryption and other TCP/IP- or UDP-related functions, such as checksum calculations.

4. The memory server architecture of claim 1, wherein
the first plurality of back-end FPGAs are programmed to include hardware agents that provide data-caching services including, but not limited to data cache eviction, memory management, cache searching, response generation, command parsing, and protocol parsing;
wherein the protocol parsing includes supporting Memcached and other similar key-value data caching libraries;
wherein the data-caching service can respond to multiple requests simultaneously.

5. The memory server architecture of claim 1, wherein
the first plurality of back-end FPGAs are programmed to process data requests providing:
a LAN interface to communicate with a LAN;
a LAN-to-NoC bridge operatively connected to the LAN interface and the NoC;
wherein the LAN-to-NoC bridge performs LAN port mapping to NoC addresses;
the NoC being operatively accessed by off-chip communication controllers;
the NoC being operatively connected to a plurality of hardware memory agents;
each hardware memory agent being connected to a plurality of memory controllers;
each memory controller being implemented entirely in the back-end FPGA, but some aspects may be implemented externally;
each memory controller is structurally connected to a plurality of RAM.

6. The memory server architecture of claim 1, wherein
the plurality of back-end FPGAs are on a multiple FPGA board providing;
multiple network connections accessible by the FPGAs;
a host interface accessible by the FPGAs;
a plurality of RAM accessible by the FPGAs;
wherein the FPGAs are structurally grouped into clusters;
wherein each FPGA in a cluster may be connected to other FPGAs in the cluster using intra-cluster communication links;
wherein each cluster may be connected to other clusters on the board using inter-cluster communication links.

7. A memory server architecture comprising:
A plurality of Application Server nodes executing software applications in an Internet-accessible environment;
wherein the plurality of Application Servers are programmed to access data from a plurality of Data Servers;
wherein the plurality of Data Servers respond to data requests from the plurality of Application Servers;
wherein the plurality of Data Servers comprises a first plurality of back-end FPGAs structured to provide access to a plurality of RAM;
wherein the first plurality of back-end FPGAs are configured to process data requests in the form of key-value or address-value pairs;
wherein a second plurality of front-end FPGAs are configured to issue data requests in the form of key-value or address-value pairs.

8. The memory server architecture of claim 7, wherein
the key in a key-value format is hashed by the back-end FPGAs to determine the Local Address on a Data Server;
and the Global Address in an address-value format is used directly by the back-end FPGAs or mapped by the back-end FPGAs to a Local Address on a Data Server.

9. The memory server architecture of claim 7, wherein
the first plurality of back-end FPGAs can perform in-line processing on the data to be stored and retrieved from the plurality of RAM on a Data Server;
wherein the in-line processing operations performed on the data includes, but is not limited to protocol parsing, key hashing, compression, encryption and other TCP/IP- or UDP-related functions, such as checksum calculations.

10. The memory server architecture of claim 7, wherein
the first plurality of back-end FPGAs are programmed to include hardware agents that provide data-caching services including, but not limited to data cache eviction, memory management, cache searching, response generation, command parsing, and protocol parsing;
wherein the protocol parsing includes supporting Memcached and other similar key-value data caching libraries;
wherein the data-caching service can respond to multiple requests simultaneously.

11. The memory server architecture of claim 7, wherein
the first plurality of back-end FPGAs are programmed to process data requests by providing:
a LAN interface to communicate with a LAN;
a LAN-to-NoC bridge operatively connected to the LAN interface and the NoC;
wherein the LAN-to-NoC bridge performs LAN port mapping to NoC addresses;
the NoC being operatively accessed by off-chip communication controllers;
the NoC being operatively connected to a plurality of hardware memory agents;
each hardware memory agent being connected to a plurality of memory controllers;
each memory controller being implemented entirely in the back-end FPGA, but some aspects may be implemented externally;
each memory controller is structurally connected to a plurality of RAM.

12. The memory server architecture of claim 7, wherein
the plurality of back-end FPGAs are on a multiple FPGA board providing;
multiple network connections accessible by the FPGAs;
a host interface accessible by the FPGAs;
a plurality of RAM accessible by the FPGAs;
wherein the FPGAs are structurally grouped into clusters;
wherein each FPGA in a cluster may be connected to other FPGAs in the cluster using intra-cluster communication links;
wherein each cluster may be connected to other clusters on the board using inter-cluster communication links.

13. The memory server architecture of claim 7, wherein
the first plurality of front-end FPGAs are programmed to issue data requests by providing:
a host interface structured to communicate with a hardware proxy module;
wherein the hardware proxy module interprets commands from an application running on an Application Server;
wherein the hardware proxy module provides efficient memory access, such as DMA, to and from the Application Server main memory;
wherein the hardware proxy may be structured to communicate with a hash engine;
wherein the hash engine is used in a key-value system to perform key hashing to determine the Data Server to access;
wherein the hash engine is used in an address-value system to map Global Addresses to determine the Data Server to access;
wherein the hash engine is structured to communicate with optional in-line pre-processing capabilities for data before it is sent for storage and after it is retrieved from storage.

14. The memory server architecture of claim 7, wherein
the first plurality of front-end FPGAs are programmed to include hardware agents that provide data-caching services including, but not limited to data cache eviction, memory management, cache searching, response generation, command parsing, and protocol parsing;
wherein the protocol parsing includes supporting Memcached and other similar key-value data caching libraries;
wherein the data-caching service can respond to multiple requests simultaneously.

15. The memory server architecture of claim 7, wherein the plurality of front-end FPGAs are on a multiple FPGA board providing;
multiple network connections accessible by the FPGAs;
a host interface accessible by the FPGAs;
a plurality of RAM accessible by the FPGAs;
wherein the FPGAs are structurally grouped into clusters;
wherein each FPGA in a cluster may be connected to other FPGAs in the cluster using intra-cluster communication links;
wherein each cluster may be connected to other clusters on the board using inter-cluster communication links.

16. The memory server architecture of claim 7, wherein
a plurality of software libraries are provided;
wherein each software library provides a high-level interface that simplifies the complexities of controlling the front-end FPGA and exchanging data with the front-end FPGA;
the API being available in a plurality of computer programming languages.

17. The memory server architecture of claim 7, wherein
two networks are used to separate the traffic between the Application Servers and the database servers, and the traffic between the Application Servers and the Data Servers;
wherein the first network is the existing LAN infrastructure connecting the Application Servers to the database servers;
wherein the second network is structured to provide connections between the front-end FPGAs to the back-end FPGAs using point-to-point links;
wherein the front-end and back-end FPGAs both perform network packet routing.
